(19) United States
(12) Patent Application Publication
(10) Pub. No.: US 2025/0140037 A1
(43) Pub. Date: May 1, 2025

(54) USER DEVICE, BASE STATION, AND COMMUNICATION METHOD

(71) Applicant: HONDA MOTOR CO., LTD., Tokyo (JP)

(72) Inventors: Takafumi Saito, Tokyo (JP); Kenji Nakanishi, Tokyo (JP)

(73) Assignee: HONDA MOTOR CO., LTD., Tokyo (JP)

(21) Appl. No.: 19/006,800

(22) Filed: Dec. 31, 2024

Related U.S. Application Data
(63) Continuation of application No. PCT/JP2022/027214, filed on Jul. 11, 2022.

(51) Int. Cl. G07C 5/08; G08G 1/01; H04W 12/04

(52) U.S. Cl. CPC G07C 5/0816; G08G 1/0133; H04W 12/04

(57) ABSTRACT

A user device mounted on a vehicle is provided. The user device is configured to transmit a message through a sidelink to a surrounding communication device, the message including a first information element indicating an automated driving level of the vehicle and a second information element indicating a traffic situation detected by the vehicle.

### CROSS-REFERENCE TO RELATED APPLICATION(S)

This application is a continuation of International Patent Application No. PCT/JP2022/027214 filed on Jul. 11, 2022, the entire disclosures of which is incorporated herein by reference.

### BACKGROUND OF THE INVENTION

### Field of the Invention

The present invention relates to a user device, a base station, and a communication method.

### Description of the Related Art

Technology for allowing two user devices in a cellular communications system to perform Vehicle-to-Everything (V2X) communication through a sidelink is standardized by the 3rd Generation Partnership Project (3GPP). US-2020-0312142 proposes technology in which a user device mounted on a vehicle evaluates safety of a surrounding environment, and transmits an alarm message to a surrounding vehicle when it is determined that there is a threat. With this technology, it is difficult to determine how reliable the alarm message is.

### SUMMARY OF THE INVENTION

Some aspects of the present invention provide technology for enabling determining reliability of a traffic situation message.

According to some embodiments, a user device mounted on a vehicle, wherein the user device is configured to transmit a message through a sidelink to a surrounding communication device, the message including a first information element indicating an automated driving level of the vehicle and a second information element indicating a traffic situation detected by the vehicle is provided.

### BRIEF DESCRIPTION OF THE DRAWINGS

FIG. 1 is a schematic diagram illustrating a configuration example of a vehicle according to some embodiments;

FIG. 2 is a schematic diagram illustrating a configuration example of a communication system according to some embodiments;

FIG. 3 is a block diagram illustrating a configuration example of a management server according to some embodiments;

FIG. 4 is a block diagram illustrating a configuration example of a base station according to some embodiments;

FIG. 5 is a block diagram illustrating a configuration example of a user device according to some embodiments;

FIG. 6 is a sequence diagram illustrating an operation example of a communication system according to some embodiments;

FIG. 7 is a diagram illustrating an example of a public key list according to some embodiments;

FIG. 8 is a diagram illustrating fields of a traffic situation message according to some embodiments;

FIG. 9 is a flowchart illustrating an operation example of a management server according to some embodiments;

FIG. 10 is a flowchart illustrating an operation example of a base station according to some embodiments;

FIG. 11 is a flowchart illustrating an operation example of a user device according to some embodiments;

FIG. 12 is a flowchart illustrating another operation example of a user device according to some embodiments; and

FIG. 13 is a flowchart illustrating still another operation example of a user device according to some embodiments.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

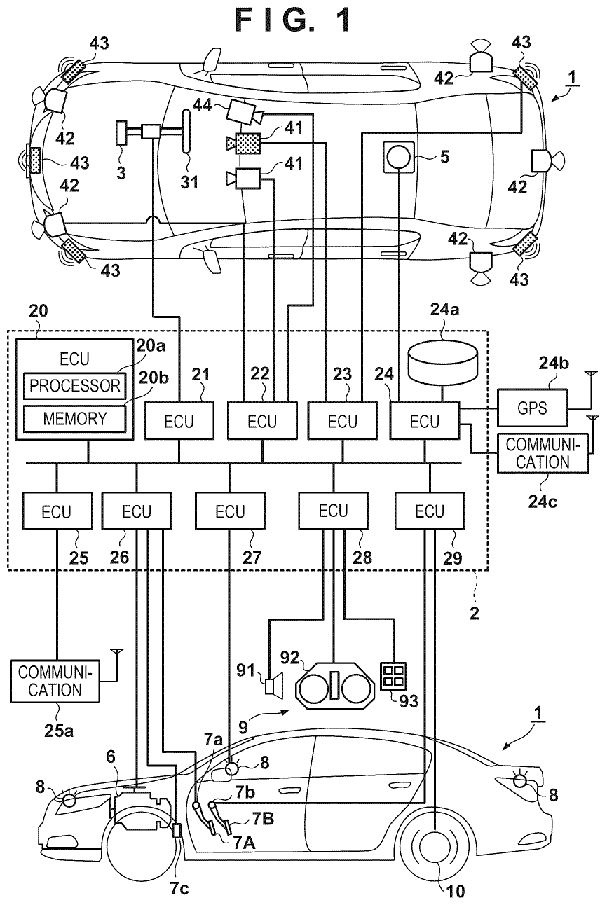

FIG. 1 is a block diagram of a vehicle 1 according to an embodiment of the present invention. In FIG. 1, the vehicle 1 is schematically illustrated in a plan view and in a side view. The vehicle 1 is, for example, a sedan-type four-wheeled passenger vehicle. The vehicle 1 may be such a four-wheeled vehicle, a two-wheeled vehicle, or any other type of vehicle.

The vehicle 1 includes a vehicle control device 2 (hereinafter, simply referred to as a control device 2) that controls the vehicle 1. The control device 2 includes a plurality of electronic control units (ECUs) 20 to 29 connected to be able to communicate with each other through an in-vehicle network. Each of the ECUs includes a processor represented by a central processing unit (CPU), a memory such as a semiconductor memory, an interface with an external device, and the like. The memory stores a program to be executed by the processor, data to be used for processing by the processor, and the like. Each of the ECUs may include a plurality of processors, memories, interfaces, and the like. For example, the ECU 20 includes a processor 20a and a memory 20b. The ECU 20 executes processing by the processor 20a executing a command included in the program stored in the memory 20b. Alternatively, the ECU 20 may include a dedicated integrated circuit such as an application specific integrated circuit (ASIC) or a field programmable gate array (FPGA) for causing the ECU 20 to execute processing. A similar configuration applies to the other ECUs.

Hereinafter, functions and the like to be performed by the respective ECUs 20 to 29 will be described. Note that the number of ECUs and functions to be performed can be designed as appropriate, and can be subdivided or integrated as compared with the present embodiment.

The ECU 20 executes control related to automated traveling of the vehicle 1. For automated driving, at least one of steering and acceleration or deceleration of the vehicle 1 is automatically controlled. The automated traveling by the ECU 20 may include automated traveling that does not require the driver to perform a traveling operation (which may also be referred to as automated driving) and automated traveling for assisting the driver in performing the traveling operation (which may also be referred to as driving assistance).

The ECU 21 controls an electric power steering device 3. The electric power steering device 3 includes a mechanism that steers front wheels in accordance with a driver's driving operation (steering operation) on a steering wheel 31. In addition, the electric power steering device 3 includes a motor that exerts a driving force for assisting the steering operation or automatically steering the front wheels, a sensor that detects a steering angle, and the like. In a case where the driving state of the vehicle 1 is the automated driving, the ECU 21 automatically controls the electric power steering device 3 in response to an instruction from the ECU 20, and controls an advancing direction of the vehicle 1.

The ECUs 22 and 23 control detection units 41 to 43 that detect a surrounding situation of the vehicle 1, and perform information processing on detection results. Further, the ECU 22 controls a detection unit 44 that detects the state of the driver of the vehicle 1, and performs information processing on detection results. The detection units 41 are cameras that capture images in front of the vehicle 1 (which may also hereinafter be referred to as cameras 41), and are attached to a windshield on an interior side of the vehicle at the front of a roof of the vehicle 1 in the present embodiment. By analyzing the images captured by the cameras 41, it is possible to extract a contour of a target object or a lane division line (white line or the like) on a road.

The detection units 42 are light detection and ranging (LiDARs) (which may also hereinafter be referred to as LiDARs 42), and detect a target object around the vehicle 1, or measure a distance to the target object. In the present embodiment, five LiDARs 42 are provided, including one at each corner of a front portion of the vehicle 1, one at a center of a rear portion of the vehicle 1, and one on each lateral side of the rear portion of the vehicle 1. The detection units 43 are millimeter-wave radars (which may also hereinafter be referred to as radars 43), and detect a target object around the vehicle 1 or measure a distance to the target object. In the present embodiment, five radars 43 are provided, including one at the center of the front portion of the vehicle 1, one at each corner of the front portion of the vehicle 1, and one at each corner of the rear portion of the vehicle 1.

The detection unit 44 is a camera that captures an image of the interior (In particular, the driver) of the vehicle 1. By analyzing the image captured by the camera 44, the ECU 22 can determine the state of the driver (for example, a line-of-sight direction, that the driver is dozing off, or the like).

The ECU 22 controls one camera 41 and each LiDAR 42 and performs information processing on the detection results. The ECU 23 controls the other camera 41 and each radar 43, and performs information processing on the detection results. By providing two sets of devices for detecting the surrounding situation of the vehicle 1, the reliability of the detection results can be improved, and by providing different types of detection units such as cameras, LiDARs, and radars, the surrounding environment of the vehicle 1 can be analyzed in multiple ways.

The ECU 24 controls a gyro sensor 5, a global navigation satellite system (GNSS) sensor 24b, and a communication device 24c, and performs information processing on detection results or communication results. The gyro sensor 5 detects a rotational movement of the vehicle 1. A course of the vehicle 1 can be determined based on a detection result of the gyro sensor 5, a wheel speed, and the like. The GNSS sensor 24b detects a current position of the vehicle 1. The communication device 24c performs wireless communication with a server that provides map information and traffic information to acquire such information therefrom. The ECU 24 can access a database 24a in which map information is stored, and the ECU 24 searches for a route from a current location to a destination. The ECU 24, the database 24a, and the GNSS sensor 24b constitute a so-called navigation device.

The ECU 25 is provided with a communication device 25a for inter-vehicle communication. The communication device 25a performs wireless communication with other surrounding vehicles to exchange information between the vehicles.

The ECU 26 controls a power plant 6. The power plant 6 is a mechanism that outputs a driving force for rotating driving wheels of the vehicle 1, and includes, for example, an engine and a transmission. For example, the ECU 26 controls the output of the engine in response to a driver's driving operation (an accelerator operation or an acceleration operation) that has been detected by an operation detection sensor 7a, which is provided on an accelerator pedal 7A, or switches a gear ratio of the transmission, based on information such as a vehicle speed that has been detected by a vehicle speed sensor 7c. When the driving state of the vehicle 1 is automated driving, the ECU 26 automatically controls the power plant 6 in response to an instruction from the ECU 20 and controls the acceleration and deceleration of the vehicle 1.

The ECU 27 controls a light device (headlight, taillight, and the like) including direction indicators 8 (blinkers). In the example of FIG. 1, the direction indicators 8 are provided at the front portion, the door mirror, and the rear portion of the vehicle 1.

The ECU 28 controls an input/output device 9. The input/output device 9 outputs information to the driver, and receives information input from the driver. A voice output device 91 notifies the driver of information by voice. A display device 92 notifies the driver of information by displaying an image. The display device 92 is disposed, for example, in front of a driver's seat, and constitutes an instrument panel or the like. Note that, although the voice and the display have been given as examples here, information may also be notified by vibration or light. In addition, information may be notified by a combination of two or more of the voice, the display, the vibration, and the light. Furthermore, the combination or the mode of notification may be changed depending on the level (for example, a degree of urgency) of information to be notified. An input device 93 is a switch group that is arranged at a position where the driver can operate it and is used to input an instruction to the vehicle 1. The input device 93 may also include a voice input device.

The ECU 29 controls a brake device 10 and a parking brake (not illustrated in the drawings). The brake device 10 is, for example, a disc brake device, and is provided on each wheel of the vehicle 1 to apply resistance against rotations of the wheels to decelerate or stop the vehicle 1. The ECU 29 controls the activation of the brake device 10 in response to a driver's driving operation (a braking operation) that has been detected by an operation detection sensor 7b, which is provided on a brake pedal 7B, for example. When the driving state of the vehicle 1 is the automated driving, the ECU 29 automatically controls the brake device 10 in response to an instruction from the ECU 20 to control the vehicle 1 to be decelerated and stopped. The brake device 10 and the parking brake can also be activated to maintain the stopped state of the vehicle 1. In addition, in a case where the transmission of the power plant 6 includes a parking lock mechanism, it is also possible to activate the parking lock mechanism to maintain the stopped state of the vehicle 1.

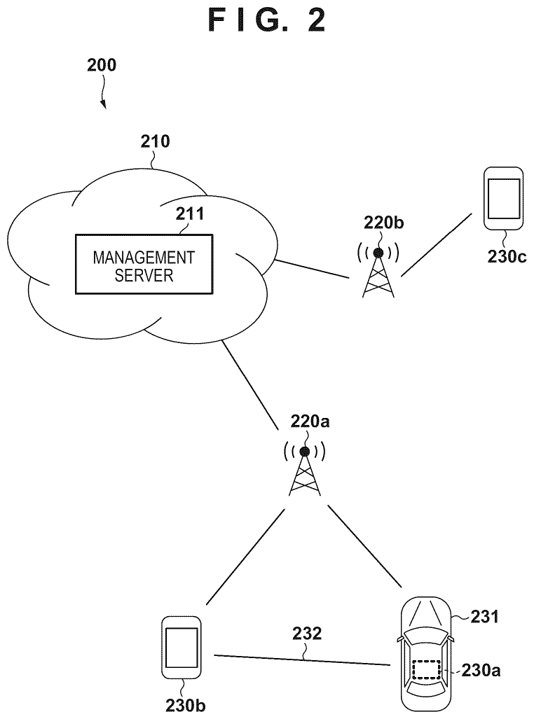

A configuration example of a wireless communication system 200 according to some embodiments will be described with reference to FIG. 2. The wireless communication system 200 may conform to a communication standard standardized by 3GPP. This communication standard may be, for example, a fourth generation (4G) standard, a fifth generation (5G) standard, or other standard.

The wireless communication system 200 includes a core network 210, a plurality of base stations 220a and 220b, and a plurality of user devices 230a to 230c. The core network 210 includes a management server 211. In the example of FIG. 2, although the wireless communication system 200 includes the two base stations 220a and 220b, the number of base stations is not limited thereto. Similarly, the number of user devices 230a to 230c included in the wireless communication system 200 is not limited to the example of FIG. 2. Hereinafter, the plurality of base stations 220a and 220b will be collectively referred to as a base station 220. The description of the base station 220 applies to each of the base stations 220a and 220b, unless otherwise specified. Similarly, the plurality of user devices 230a to 230c are collectively referred to as a user device 230.

The core network 210 is a network including a plurality of devices for providing communication services to the user device 230. Specifically, the core network 210 enables communication between two user devices 230 and communication between the user device 230 and another communication device connected to an external network (for example, the Internet). The core network 210 may be an evolved packet core (EPC) conforming to the 4G standard, may be a 5G core (5GC) conforming to the 5G standard, or may be another core network. The management server 211 manages information regarding the user device 230. Details of this information will be described later. In the example of FIG. 2, the management server 211 is included in the core network 210. Alternatively, the management server 211 may be connected to the core network 210 from the outside.

The base station 220 is a device that relays communication between the core network 210 and the user device 230. The base station 220 may be an eNodeB conforming to the 4G standard, may be a gNodeB conforming to the 5G standard, or may be other base station. Typically, the core network 210 and the base station 220 are connected by wire. The base station 220 and the user device 230 are wirelessly connected. In the example of FIG. 2, the base station 220a is connected to the user devices 230a and 230b, and the base station 220b is connected to the user device 230b. In other words, the base station 220a provides services to the user devices 230a and 230b, and the base station 220b provides services to the user device 230b.

The user device 230 is a communication device that can use a communication service provided by the core network 210. In the example of FIG. 2, the user device 230a is an in-vehicle device mounted on a vehicle 231, and the user devices 230b and 230c are mobile devices carried by the user. The type of the user device is not limited thereto, and may be, for example, an IoT (Internet of Things) device. The vehicle 231 may have the same configuration as the vehicle 1, and the user device 230a may be the communication device 24c of the vehicle 1.

Further, the user device 230 may be capable of sidelink communication. The sidelink communication is wireless communication directly performed by two user devices 230 located in the vicinity. For example, the user device 230a and the user device 230b perform the sidelink communication through a sidelink 232 (wireless communication link). The sidelink 232 may conform to the PC5 interface. The user device 230 may operate as a client of a V2X application.

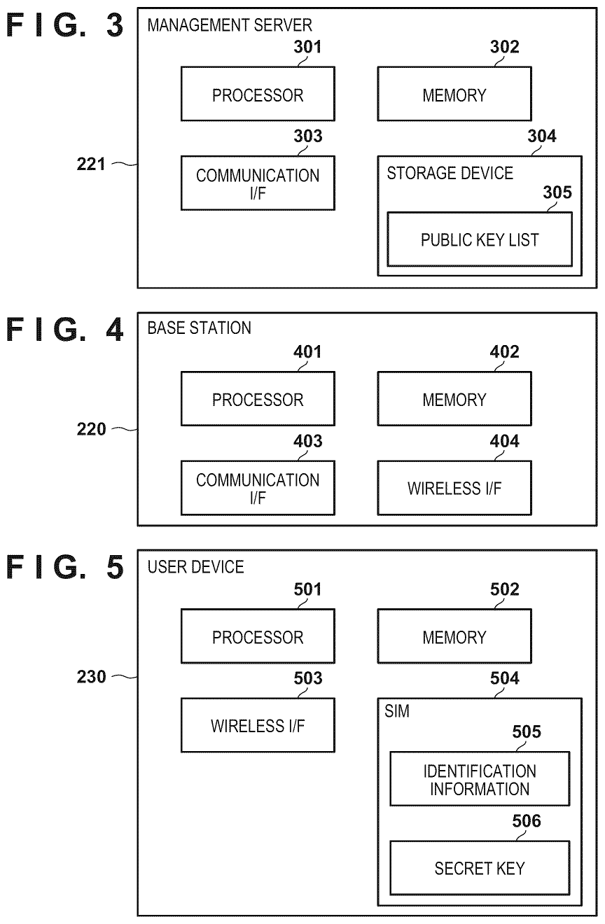

A hardware configuration example of the management server 211 will be described with reference to FIG. 3. The management server 211 includes a processor 301, a memory 302, a communication interface (I/F) 303, and a storage device 304.

The processor 301 is a general-purpose processing circuit for executing the overall operation of the management server 211. The management server 211 may include only a single processor 301 or may include a plurality of processors 301. The processor 301 may be realized by, for example, a central processing unit (CPU).

The memory 302 is a circuit for storing data and a computer program used for the operation of the management server 211. The management server 211 may include only a single memory 302 or may include a plurality of memories 302. The memory 302 may be realized by a combination of a nonvolatile storage medium such as a read only memory (ROM) and a volatile storage medium such as a random access memory (RAM). The operation by the management server 211 may be performed, for example, by the processor 301 executing a program read into the memory 302.

The communication I/F 303 is a device for communicating with another communication device. The communication I/F 303 may be realized by, for example, a network card as long as wired communication is performed, or may be realized by, for example, an antenna and a signal processing circuit as long as wireless communication is performed.

The storage device 304 is a device for storing information used for the operation of the management server 211. The storage device 304 may be realized by a hard disk drive (HDD) or a solid state drive (SSD). The storage device 304 stores a public key list 305. Details of the public key list 305 will be described later. In the example of FIG. 3, the storage device 304 stores the public key list 305. Alternatively, the public key list 305 may be stored in an external device (for example, a database server), and the processor 301 may acquire the public key list 305 from the external device.

A hardware configuration example of the base station 220 will be described with reference to FIG. 4. The base station 220 includes a processor 401, a memory 402, a communication I/F 403, and a wireless I/F 404. The processor 401 is a general-purpose processing circuit for executing the overall operation of the base station 220. The base station 220 may include only a single processor 401, or may include a plurality of processors 401. The processor 401 may be realized by, for example, a CPU.

The memory 402 is a circuit for storing data and a computer program used for the operation of the base station 220. The base station 220 may include only a single memory 402, or may include a plurality of memories 402. The memory 402 may be realized by a combination of a nonvolatile storage medium such as a ROM and a volatile storage medium such as a RAM. The operation by the base station 220 may be performed, for example, by the processor 401 executing a program read into the memory 402.

The communication I/F 403 is a device for communicating with the core network 210. The communication I/F 403 may be realized by, for example, a network card as long as wired communication is performed, or may be realized by, for example, an antenna and a signal processing circuit as long as wireless communication is performed. The wireless I/F 404 is a device for communicating with the user device 230. The wireless I/F 404 may be realized by, for example, an antenna and a signal processing circuit.

A hardware configuration example of the user device 230 will be described with reference to FIG. 5. The user device 230 includes a processor 501, a memory 502, a wireless I/F 503, and a subscriber identity module (SIM) 504. The processor 501 is a general-purpose processing circuit for executing the overall operation of the user device 230. The user device 230 may include only a single processor 501, or may include a plurality of processors 501. The processor 501 may be realized by, for example, a CPU.

The memory 502 is a circuit for storing data and a computer program used for the operation of the user device 230. The user device 230 may include only a single memory 502, or may include a plurality of memories 502. The memory 502 may be realized by a combination of a nonvolatile storage medium such as a ROM and a volatile storage medium such as a RAM. The operation by the user device 230 may be performed, for example, by the processor 501 executing a program read into the memory 502.

The wireless I/F 503 is a device for communicating with the base station 220. The wireless I/F 503 may be realized by, for example, an antenna and a signal processing circuit. The wireless I/F 503 may also be used to communicate with other user devices through a sidelink.

The SIM 504 is a module that stores information used by the core network 210 to identify a subscriber. The SIM 504 may be provided by a universal subscriber identity module (UICC), or may be an eSIM. The SIM 504 stores identification information 505 and a secret key 506. The identification information 505 is information for uniquely identifying the user device 230. The identification information 505 may be an international mobile subscriber identity (IMSI) or other identification information. The secret key 506 is a key used for encrypting/decrypting data together with a public key forming a pair. The secret key 506 may be assigned by the core network 210 to the user device 230. In this case, the public key paired with the secret key 506 may be stored in the core network 210.

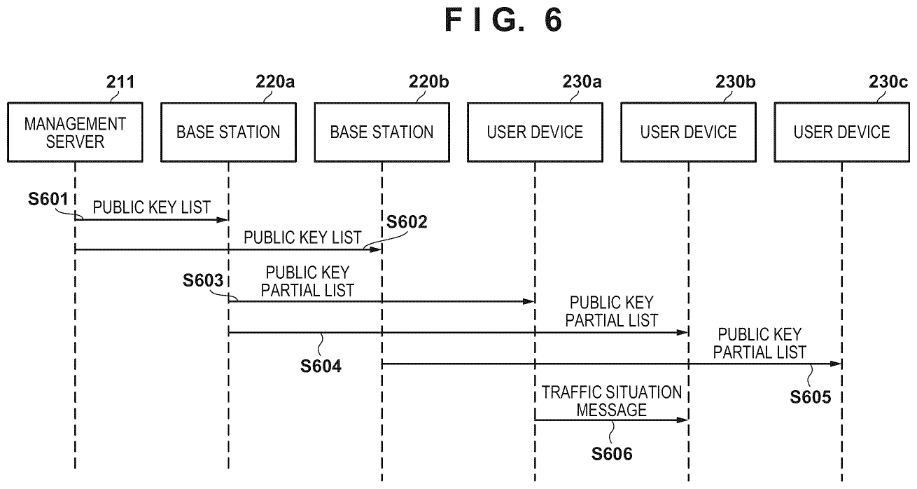

An example of an overall operation flow of the wireless communication system 200 will be described with reference to FIG. 6. The management server 211 transmits the public key list 305 to the base station 220a in S601, and transmits the public key list 305 to the base station 220b in S602. As such, the management server 211 transmits the same public key list 305 to each of the plurality of base stations 220. The management server 211 may transmit the public key list 305 starting from any base station 220 of the plurality of base stations 220. The public key list 305 is a list of public keys paired with the secret keys 506 stored in the plurality of user devices 230, respectively.

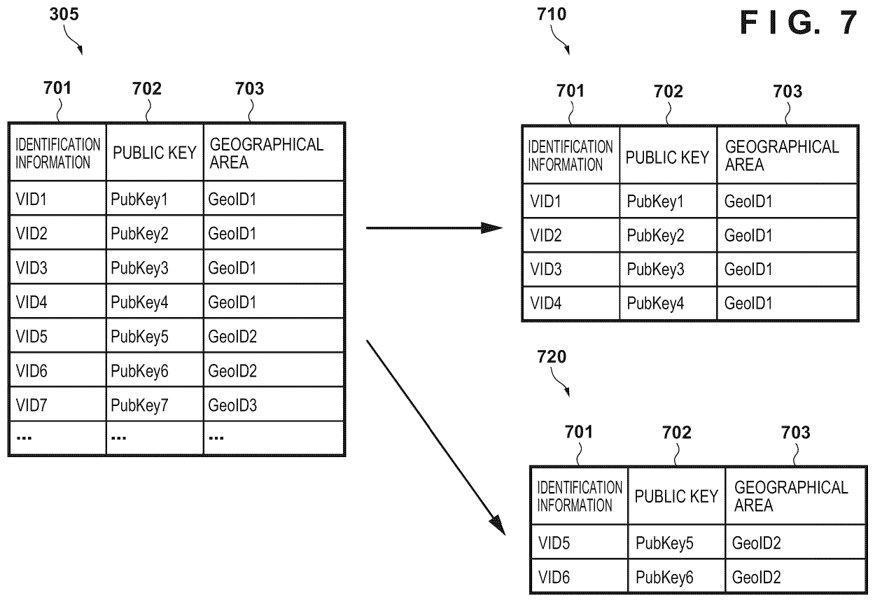

An example of the public key list 305 will be described with reference to FIG. 7. The public key list 305 has a plurality of records. The plurality of records in the public key list 305 include information indicated in columns 701 to 703 for each user device 230. The column 701 indicates identification information of each user device 230. The identification information indicated in the column 701 may be the same as the identification information 505 stored in the SIM 504 of the user device 230. The column 702 indicates a public key paired with the secret key 506 stored in each user device 230. The column 703 indicates information of a geographical area in which each user device 230 is located. The column 703 may be indicated by an identifier uniquely assigned to each geographical area.

The geographical area indicated in the column 730 may be a coverage of the base station 220. Alternatively, the geographical area may be an area set independently of the coverage of the base station 220. For example, the geographical area may be set based on an area divided by a road. The information indicating the geographical area may be managed by the management server 211, or may be managed by a server different from the management server 211. The user device 230 may acquire information indicating the geographical area from a server that manages the geographical area, and determine, based on the information, in which geographical area among a plurality of geographical areas the user device 230 is located. A current position of the user device 230 may be determined based on a measurement result by a positioning sensor, or may be determined based on a positional relation with the base station 220. For example, in a case where the user device 230 has a positioning sensor, or in a case where a device (for example, the vehicle 231) on which the user device 230 is mounted has a positioning sensor (for example, the GNSS sensor 24b), the user device 230 may determine the current position of the user device 230 based on a measurement result by the positioning sensor.

Each time the secret key 506 is assigned to the user device 230, the management server 211 may add a record for the user device 230 to the public key list 305. In addition, in a case where the secret key 506 of the user device 230 is changed, the management server 211 may update the public key list 305 so as to update the public key indicated in the column 702. In addition, the management server 211 may receive, from the user device 230, information indicating a geographical area in which the user device 230 is located, and update the information of the geographical area indicated in the column 703 based on the information. The user device 230 may report the current geographical area to the management server 211 each time the geographical area in which it is currently located changes.

The management server 211 may include a record in the public key list 305 only for the user device 230 that satisfies a specific condition. For example, the specific condition may be that the user device 230 is mounted on a vehicle having a predetermined automated driving level. The automated driving level may be, for example, a level defined by the Society of Automotive Engineers (SAE) of the United States. The SAE defines 6 levels of levels 0 to 5 as follows. At the level 0, the automated driving is not performed. At the level 1, driving assistance is provided in a limited situation. In the driving assistance of the level 1, the driver is required to hold the steering wheel and monitor the surroundings. At the level 2, partial driving automation is realized, and driving is performed autonomously by the vehicle in a limited situation. In the automated driving at the level 2, the driver is not required to hold the steering wheel, but is required to monitor the surroundings. At the level 3, conditional driving automation is realized, and driving is performed autonomously by the vehicle in a limited situation. In the automated driving at the level 3, the driver is not required to hold the steering wheel and monitor the surroundings. At the level 4, advanced driving automation is realized, and driving is performed autonomously by the vehicle in a limited situation. In the automated driving at the level 4, the driver is not required to hold the steering wheel and monitor the surroundings, and the driver does not need to pay attention to the driving operation. At the level 5, full driving automation is realized, and driving is performed autonomously by the vehicle in any situation. In the automated driving at the level 5, the driver is not required to hold the steering wheel and monitor the surroundings, and the driver does not need to pay attention to the driving operation. At the levels 0 to 2, the vehicle is driven by a person (driver), and at the levels 3 to 5, the vehicle is driven by the vehicle itself. The automated driving level may be a level certified by a certification organization (for example, a national agency: the Ministry of Land, Infrastructure, Transport and Tourism in the case of Japan) for the vehicle.

For example, the specific condition may be that the user device 230 is mounted on a vehicle having an automated driving level of the level 2 or higher. In this case, when the user device 230 is mounted on a vehicle having an automated driving level of the level 1 or lower or the user device 230 is not mounted on a vehicle, a record for the user device 230 is not generated in the public key list 305. Therefore, the public keys for these user devices 230 are not transmitted from the management server 211 to the base station 220. Alternatively, the specific condition may be that the user device 230 is mounted on a vehicle having an automated driving level of another level or higher. Whether or not the user device 230 is mounted on a vehicle having a predetermined automated driving level may be determined based on a model of the vehicle and a certification result by a certification organization.

Returning to the description of FIG. 6, the base station 220a transmits a public key partial list 710 (described later) to the user device 230a in S603, and transmits the public key partial list 710 to the user device 230b in S604. As such, the base station 220a transmits the same public key partial list 710 to each of the plurality of user devices 230 to which the base station 220a provides services. In S605, the base station 220b transmits a public key partial list 720 (described later) to the user device 230c. As such, the base station 220b transmits the same public key partial list 720 to each of the plurality of user devices 230 to which the base station 220b provides services. The base station 220 may transmit the public key partial list starting from any user device 230 of the plurality of user devices 230 to which the base station 220 provides services.

An example of the public key partial lists 710 and 720 will be described with reference to FIG. 7 again. The public key partial lists 710 and 720 are lists generated by extracting some records from the public key list 305. Therefore, the public key partial lists 710 and 720 may have the same columns 701 to 703 as those in the public key list 305. The public key partial list 710 is a list generated by extracting a record having a geographical area (for example, “GeoID1”) included in the coverage of the base station 220a in the public key list 305. The public key partial list 720 is a list generated by extracting a record having a geographical area (for example, “GeoID2”) included in the coverage of the base station 220b in the public key list 305. The public key partial list 710 and the public key partial list 720 may be different from each other, or may partially overlap each other.

Returning to the description of FIG. 6, in S606, the user device 230a mounted on the vehicle 231 transmits a traffic situation message 800 (described later) to the user device 230b through the sidelink 232. The traffic situation message 800 is a message indicating the traffic situation detected by the vehicle 231.

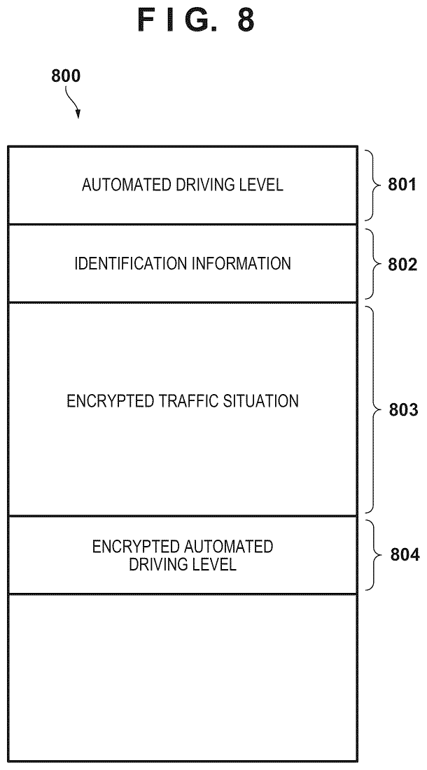

An example of a format of the traffic situation message 800 will be described with reference to FIG. 8. The traffic situation message 800 includes information elements 801 to 804. Each of the information elements 801 to 804 is stored in a separate field of the traffic situation message 800.

The information element 801 indicates an automated driving level of the vehicle 231 on which the user device 230a is mounted. As described above, the automated driving level may be a level defined by the SAE, or may be a level certified by a certification organization. The information element 801 may be a numerical value indicating the automated driving level or a binary flag indicating that the automated driving level satisfies a predetermined condition (for example, the level 2 or higher). The information element 802 indicates the identification information 505 of the user device 230a.

The information element 803 indicates the traffic situation detected by the vehicle 231. The traffic situation may include a situation regarding the vehicle 231, a situation around the vehicle 231, or both of them. The situation around the vehicle 231 may be, for example, a situation of a traffic participant (for example, an automobile, a bicycle, or a pedestrian) around the vehicle 231, a road state (for example, fallen objects and potholes) around the vehicle 231, a situation of an installation (for example, a traffic light and a guard rail) around the vehicle 231, or the like. The situation around the vehicle 231 may be determined by the ECU of the vehicle 231 based on, for example, detection results by the detection units 41 to 43 of the vehicle 231. The situation regarding the vehicle 1 may include a situation of a driver of the vehicle 231 (for example, the driver is in a dozing state or a drunk state), a situation regarding acceleration/deceleration or steering of the vehicle 231 (for example, sudden start, sudden stop, or deviation from a lane), and the like. The situation regarding the vehicle 231 may be determined by the ECU of the vehicle 231 based on, for example, a detection result by the detection unit 44 of the vehicle 231 or a result of detection by the wheel speed sensor and the steering angle sensor.

The traffic situation indicated by the information element 803 may include, for example, a traffic situation requiring attention due to posing a threat to safety. Such a traffic situation requiring attention may be, for example, that the driver of the vehicle 231 is dozing or drunk, that the vehicle around the vehicle 231 is suddenly accelerating or deviating from a lane, or the like. The information element 803 may be encrypted by the secret key 506 stored in the user device 230a, or may be a plaintext.

The information element 804 is an information element obtained by encrypting the information element 801 with the secret key 506 of the user device 230a. That is, the information element 804 indicates an encrypted automated driving level. As such, the traffic situation message 800 includes a plaintext automated driving level as the information element 801 and an encrypted automated driving level as the information element 804. Alternatively, the traffic situation message 800 may include only one of the information element 801 and the information element 804.

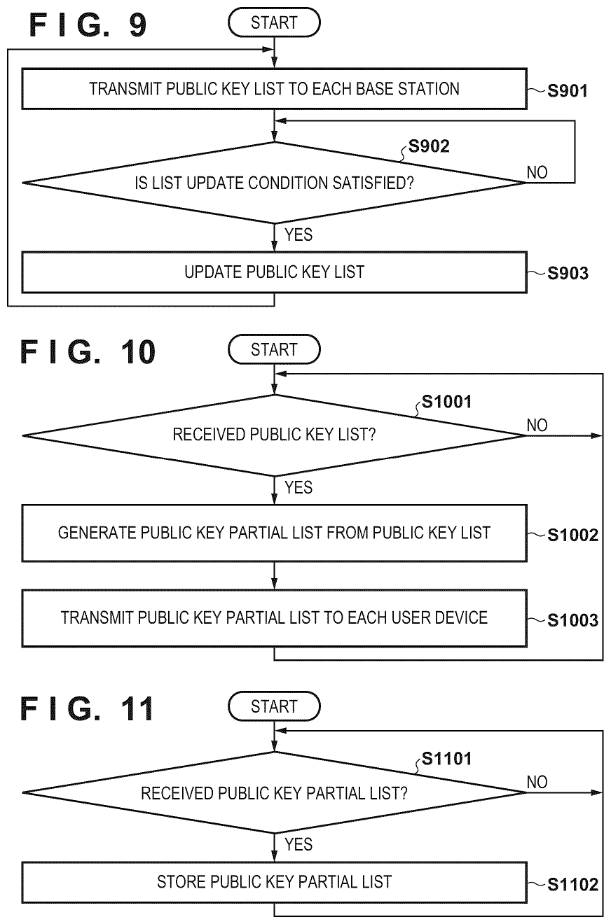

An operation example of the management server 211 will be described with reference to FIG. 9. In a method of FIG. 9, the management server 211 communicates with the base station 220. The method of FIG. 9 may be performed by the processor 301 of the management server 211 executing a computer program read into the memory 302 of the management server 211. Alternatively, some or all steps in the method of FIG. 9 may be performed by a dedicated circuit such as an application-specific integrated circuit (ASIC). The method of FIG. 9 may be started in response to the start of the management server 211.

In S901, the management server 211 transmits the public key list 305 to each of the plurality of base stations 220. As described above, the public key list 305 includes a public key paired with a secret key (for example, the secret key 506) stored in a communication device (for example, the user device 230a) mounted on a vehicle (for example, the vehicle 231) having a predetermined automated driving level.

In S902, the management server 211 determines whether or not a condition for updating the public key list 305 is satisfied. In a case where it is determined that this condition is satisfied (“YES” in S902), the management server 211 shifts the processing to S903, and in the other case (“NO” in S902), the management server 211 repeats S902. The condition for updating the public key list 305 may include, for example, that a secret key is assigned to the user device 230 mounted on a vehicle having a predetermined automated driving level, that information (that is, the information of the geographical area) in the column 703 of the existing record is updated, and the like.

In S903, the management server 211 updates the public key list 305, returns the processing to S901, and transmits the updated public key list 305 to each base station 220. In this manner, the public key list 305 reflecting the latest state is provided to each base station 220.

An operation example of the base station 220 will be described with reference to FIG. 10. In a method of FIG. 10, the base station 220 communicates with the management server 211 and the user device 230. The method of FIG. 10 may be performed by the processor 401 of the base station 220 executing a computer program read into the memory 402 of the base station 220.

Alternatively, some or all steps in the method of FIG. 10 may be performed by a dedicated circuit such as an ASIC. The method of FIG. 10 may be started in response to the start of the base station 220.

In S1001, the base station 220 determines whether or not the public key list 305 has been received from the management server 211. In a case where it is determined that the public key list 305 has been received (“YES” in S1001), the base station 220 shifts the processing to S1002, and in the other case (“NO” in S1001), the base station 220 repeats S1001.

In S1002, the base station 220 generates a public key partial list from the public key list 305. Specifically, the base station 220 identifies a geographical area included in its coverage, and extracts a record matching this geographical area from the public key list 305.

In S1003, the base station 220 transmits the generated public key partial list to the user device to which the base station 220 provides services. Thereafter, the base station 220 returns the processing to S1001 and waits for reception of the updated public key list 305. In S1003, the base station 220 transmits a public key of the user device 230 located in the geographical area serviced by the base station 220 among a plurality of public keys included in the public key list 305, to the user device 230 in the geographical area serviced by the base station 220. For example, when the user device 230a and the user device 230b are located in the same geographical area, a public key partial list including a public key of the user device 230a is transmitted to both the user device 230a and the user device 230b. On the other hand, the base station 220 does not transmit a public key of the user device 230 not located in the geographical area serviced by the base station 220 among the plurality of public keys included in the public key list 305, to the user device 230 in the geographical area serviced by the base station 220. For example, when the user device 230a and the user device 230b are located in the same geographical area, the public key of the user device 230 not included in the geographical area is transmitted to neither the user device 230a nor the user device 230b.

An operation example of the user device 230 will be described with reference to FIG. 11. In a method of FIG. 11, the user device 230 communicates with the base station 220. The method of FIG. 11 may be performed by the processor 501 of the user device 230 executing a computer program read into the memory 502 of the user device 230. Alternatively, some or all steps in the method of FIG. 11 may be performed by a dedicated circuit such as an ASIC. The method of FIG. 11 may be started in response to the start of the user device 230.

In S1101, the user device 230 determines whether or not a public key partial list has been received from the base station 220. In a case where it is determined that the public key partial list has been received (“YES” in S1101), the user device 230 shifts the processing to S1102, and in the other case (“NO” in S1101), the user device 230 repeats S1101.

In S1102, the user device 230 stores the public key partial list in the memory 502 for use in subsequent processing. In a case where the public key partial list is already stored in the memory 502, the user device 230 may overwrite the original public key partial list with a new public key partial list. Thereafter, the user device 230 returns the processing to S1101, and waits for reception of the updated public key partial list.

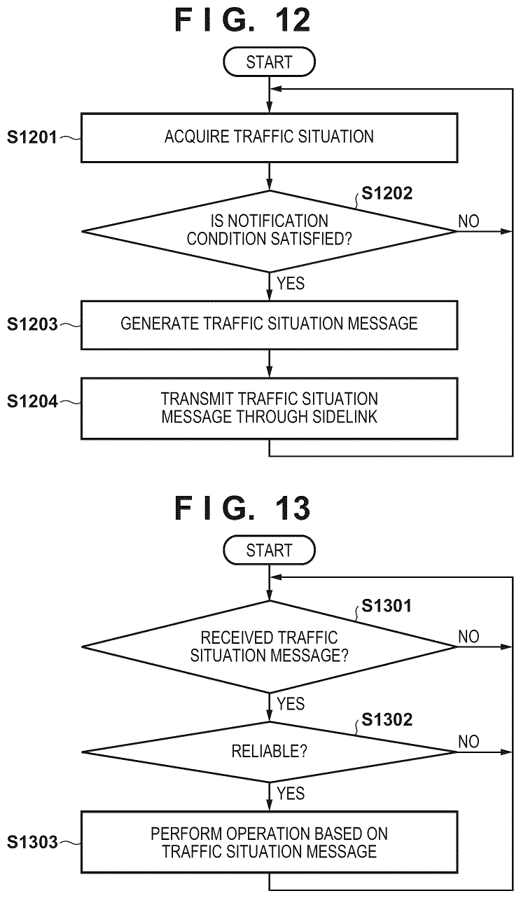

An operation example of the user device 230a mounted on the vehicle 231 will be described with reference to FIG. 12. In a method of FIG. 12, the user device 230a communicates with another user device 230. The method of FIG. 12 may be performed by the processor 501 of the user device 230a executing a computer program read into the memory 502 of the user device 230a. Alternatively, some or all steps in the method of FIG. 12 may be performed by a dedicated circuit such as an ASIC. The method of FIG. 12 may be started in response to the start of the user device 230a. The method of FIG. 12 may be performed in parallel with the method of FIG. 11.

In S1201, the user device 230a acquires a traffic situation regarding the vehicle 1 or around the vehicle 1. An example of the acquired traffic situation may be the same as the traffic situation described with reference to FIG. 8.

In S1202, the user device 230a determines whether or not the traffic situation satisfies a notification condition. In a case where it is determined that the traffic situation satisfies the notification condition (“YES” in S1202), the user device 230a shifts the processing to S1203, and in the other case (“NO” in S1202), the user device 230a shifts the processing to S1201. The notification condition is a condition for the user device 230a to transmit the traffic situation message 800 to another user device. The notification condition may be that the traffic situation acquired in S1201 is a traffic situation requiring attention. Alternatively, the notification condition may be that the traffic situation acquired in S1201 is a traffic situation satisfying another predetermined condition.

In S1203, the user device 230a generates the traffic situation message 800. For example, the user device 230a reads the automated driving level from the vehicle 1 and encrypts it using the secret key 506. The user device 230a also encrypts the traffic situation using the secret key 506. Then, the user device 230a generates the traffic situation message 800 by including necessary information in each field.

In S1204, the user device 230a transmits the traffic situation message to the surrounding user device 230b through the sidelink 232. Thereafter, the user device 230a returns the processing to S1201, and repeats S1201 to S1204.

An operation example of the user device 230 will be described with reference to FIG. 13. In a method of FIG. 13, the user device 230 communicates with another user device 230. The method of FIG. 13 may be performed by the processor 501 of the user device 230 executing a computer program read into the memory 502 of the user device 230. Alternatively, some or all steps in the method of FIG. 13 may be performed by a dedicated circuit such as an ASIC. The method of FIG. 13 may be started in response to the start of the user device 230. The method of FIG. 13 may be performed in parallel with the method of FIG. 11 and the method of FIG. 12.

In S1301, the user device 230 determines whether or not a traffic situation message has been received from the surrounding user device 230 through the sidelink. In a case where it is determined that the traffic situation message has been received (“YES” in S1301), the user device 230 shifts the processing to S1302, and in the other case (“NO” in S1301), the user device 230 repeats S1301.

In S1302, the user device 230 determines whether or not the received traffic situation message is reliable. In a case where it is determined that the traffic situation message is reliable (“YES” in S1302), the user device 230 shifts the processing to S1303, and in the other case (“NO” in S1302), the user device 230 repeats S1301.

The user device 230 may determine that the traffic situation message is reliable, for example, when the automated driving level indicated in the information element 801 of the traffic situation message 800 satisfies a predetermined condition (for example, the level 2 or higher). For example, when the automated driving level is the level 2 or higher, it is considered that the detection accuracy of the vehicle that has detected the traffic situation included in the traffic situation message is high. Therefore, the user device 230 can perform processing with reliability of the traffic situation included in the traffic situation message 800.

Additionally or alternatively, the user device 230 determines a record having identification information matching the information element 802 of the traffic situation message 800 among a plurality of records included in the public key partial list obtained by the method of FIG. 11. The user device 230 may decrypt the information element 804 of the traffic situation message 800 by using a public key of the determined record, and when a decryption result matches the information element 801 of the traffic situation message 800, the user device 230 may determine that the traffic situation message is reliable. As such, in a case where the decryption result of the information element 804 matches the information element 801, it is considered that the information element 801 (that is, the automated driving level) is not falsified.

Additionally or alternatively, the user device 230 may determine that the traffic situation message 800 is reliable, when the information element 803 of the traffic situation message 800 can be decrypted by using the public key obtained by the method of FIG. 11. It is considered that the information element 803 (that is, the traffic situation) is not falsified.

In S1303, the user device 230 performs an operation based on the traffic situation message. This operation may be any operation, or may be a preset operation. For example, the user device 230 may issue an alarm to the user. When the user device 230 is mounted on a vehicle, the user device 230 may provide a traffic situation included in the traffic situation message to the vehicle, and the vehicle may perform an operation (for example, an avoidance operation from a risk factor) based on the traffic situation. On the other hand, when it is determined that the traffic situation message 800 is not reliable, the user device 230 may discard the traffic situation message 800. Thereafter, the user device 230 returns the processing to S1301, and waits for reception of a new traffic situation message.

As described above, in S1302, the user device 230 uses the public key of the surrounding user device 230 to decrypt the information element of the traffic situation message 800 obtained from the surrounding user device 230. The user device 230 that generates the traffic situation message 800 (that is, uses the secret key 506) is likely to be included in the same geographical area as the user device 230 that uses the public key. Therefore, the base station 220 does not include an unnecessary public key in the public key partial list. As a result, the communication amount is reduced as compared with a case where the entire public key list 305 is provided.

In the embodiments described above, the public key partial lists 710 and 720 includes information of the geographical area (column 703). Alternatively, the public key partial lists 710 and 720 may not include the information of the geographical area (column 703).

### Summary of Embodiments

<Item 1> A user device (230a) mounted on a vehicle (231), wherein
the user device is configured to transmit a message (800) through a sidelink (232) to a surrounding communication device (230b), the message including a first information element (801) indicating an automated driving level of the vehicle and a second information element (803) indicating a traffic situation detected by the vehicle.

According to this item, since the automation level of the vehicle on which the user device that has generated the message is mounted is included in the message, it is possible to determine how reliable the traffic situation indicated by the message is.

<Item 2> The user device according to Item 1, wherein
the message further includes a third information element (802) indicating identification information of the user device.

According to this item, it is possible to uniquely identify the user device that has generated the message.

<Item 3> The user device according to Item 1 or 2, wherein
the message further includes a fourth information element (804) obtained by encrypting the first information element by using a secret key (506) stored in the user device.

According to this item, since it can be determined that the automated driving level is not falsified, it is possible to more effectively determine how reliable the traffic situation indicated by the message is.

<Item 4> The user device according to any one of Items 1-3, wherein
the second information element is encrypted by a secret key (506) stored in the user device.

According to this item, since it can be determined that the traffic situation is not falsified, it is possible to more effectively determine how reliable the traffic situation indicated by the message is.

<Item 5> The user device according to any one of Items 1-4, wherein
the traffic situation indicated by the second information element includes a traffic situation requiring attention.

According to this item, it is possible to determine how reliable the traffic situation requiring attention is.

<Item 6> A user device (230b), wherein
the user device is configured to receive a message (800) through a sidelink (232) from a surrounding communication device (230a) mounted on a vehicle (231), the message including a first information element (801) indicating an automated driving level of the vehicle and a second information element (803) indicating a traffic situation detected by the vehicle.

According to this item, since the automation level of the vehicle on which the user device that has generated the message is mounted is included in the message, it is possible to determine how reliable the traffic situation indicated by the message is.

<Item 7> The user device according to Item 6, wherein
the user device is configured to further receive, from a base station (220), a public key paired with a secret key (506) stored in a user device (231a) mounted on a vehicle (231) having a predetermined automated driving level.

According to this item, the encrypted information element included in the received message can be decrypted.

<Item 8> The user device according to Item 6 or 7, wherein
the message further includes a third information element (802) indicating identification information of the communication device.

According to this item, it is possible to uniquely identify the user device that has generated the message.

<Item 9> The user device according to any one of Items 6-8, wherein
the message further includes a fourth information element (804) obtained by encrypting the first information element by using a secret key (506) stored in the communication device.

According to this item, since it can be determined that the automated driving level is not falsified, it is possible to more effectively determine how reliable the traffic situation indicated by the message is.

<Item 10> The user device according to any one of Items 6-9, wherein
the second information element is encrypted by a secret key (506) stored in the communication device.

According to this item, since it can be determined that the traffic situation is not falsified, it is possible to more effectively determine how reliable the traffic situation indicated by the message is.

<Item 11> The user device according to any one of Items 6-10, wherein
the traffic situation indicated by the second information element includes a traffic situation requiring attention.

According to this item, it is possible to determine how reliable the traffic situation requiring attention is.

<Item 12> A base station (220), wherein
the base station is configured to transmit, to a user device (230), a public key paired with a secret key (506) stored in a communication device (230a) mounted on a vehicle (231) having a predetermined automated driving level.

According to this item, the encrypted information element included in the message received by the user device can be decrypted.

<Item 13> The base station according to Item 12, wherein the base station is configured to
receive a list (305) including a plurality of records from a management server (211), each of the plurality of records including a public key (702) paired with a secret key stored in an individual communication device, and information (703) indicating a geographical area in which the individual communication device is located,
transmit a public key of a communication device, which is located in a geographical area serviced by the base station, among a plurality of public keys included in the list, to a user device in the geographical area serviced by the base station, and
not to transmit a public key of a communication device, which is not located in the geographical area serviced by the base station, among the plurality of public keys included in the list, to the user device in the geographical area serviced by the base station.

According to this item, an amount of data transmitted from the base station to the user device can be reduced.

<Item 14> A communication method performed by a user device (230a) mounted on a vehicle (231), the method comprising:
transmitting a message through a sidelink (232) to a surrounding communication device (230b), the message (800) including a first information element (801) indicating an automated driving level of the vehicle and a second information element (803) indicating a traffic situation detected by the vehicle.

According to this item, since the automation level of the vehicle on which the user device that has generated the message is mounted is included in the message, it is possible to determine how reliable the traffic situation indicated by the message is.

<Item 15> A communication method performed by a user device (230b), the method comprising:
receiving a message (800) through a sidelink (232) from a surrounding communication device (230a) mounted on a vehicle, the message including a first information element (801) indicating an automated driving level of the vehicle and a second information element (803) indicating a traffic situation detected by the vehicle.

According to this item, since the automation level of the vehicle on which the user device that has generated the message is mounted is included in the message, it is possible to determine how reliable the traffic situation indicated by the message is.

<Item 16> A communication method performed by a base station (220), the method comprising:
transmitting a public key, to a user device (230), which is paired with a secret key (506) stored in a communication device (230a) mounted on a vehicle (231) having a predetermined automated driving level.

The invention is not limited to the foregoing embodiments, and various variations/changes are possible within the spirit of the invention.

What is claimed is:

1. A user device mounted on a vehicle, wherein
the user device is configured to transmit a message through a sidelink to a surrounding communication device, the message including a first information element indicating an automated driving level of the vehicle and a second information element indicating a traffic situation detected by the vehicle.

2. The user device according to claim 1, wherein
the message further includes a third information element indicating identification information of the user device.

3. The user device according to claim 1, wherein
the message further includes a fourth information element obtained by encrypting the first information element by using a secret key stored in the user device.

4. The user device according to claim 1, wherein
the second information element is encrypted by a secret key stored in the user device.

5. The user device according to claim 1, wherein
the traffic situation indicated by the second information element includes a traffic situation requiring attention.

6. A user device, wherein
the user device is configured to receive a message through a sidelink from a surrounding communication device mounted on a vehicle, the message including a first information element indicating an automated driving level of the vehicle and a second information element indicating a traffic situation detected by the vehicle.

7. The user device according to claim 6, wherein
the user device is configured to further receive, from a base station, a public key paired with a secret key stored in a user device mounted on a vehicle having a predetermined automated driving level.

8. The user device according to claim 6, wherein
the message further includes a third information element indicating identification information of the communication device.

9. The user device according to claim 6, wherein
the message further includes a fourth information element obtained by encrypting the first information element by using a secret key stored in the communication device.

10. The user device according to claim 6, wherein
the second information element is encrypted by a secret key stored in the communication device.

11. The user device according to claim 6, wherein
the traffic situation indicated by the second information element includes a traffic situation requiring attention.

12. A base station, wherein
the base station is configured to transmit, to a user device, a public key paired with a secret key stored in a communication device mounted on a vehicle having a predetermined automated driving level.

13. The base station according to claim 12, wherein the base station is configured to
receive a list including a plurality of records from a management server, each of the plurality of records including a public key paired with a secret key stored in an individual communication device, and information indicating a geographical area in which the individual communication device is located,
transmit a public key of a communication device, which is located in a geographical area serviced by the base station, among a plurality of public keys included in the list, to a user device in the geographical area serviced by the base station, and
not to transmit a public key of a communication device, which is not located in the geographical area serviced by the base station, among the plurality of public keys included in the list, to the user device in the geographical area serviced by the base station.

14. A communication method performed by a user device mounted on a vehicle, the method comprising:
transmitting a message through a sidelink to a surrounding communication device, the message including a first information element indicating an automated driving level of the vehicle and a second information element indicating a traffic situation detected by the vehicle.

15. A communication method performed by a user device, the method comprising:
receiving a message through a sidelink from a surrounding communication device mounted on a vehicle, the message including a first information element indicating an automated driving level of the vehicle and a second information element indicating a traffic situation detected by the vehicle.

16. A communication method performed by a base station, the method comprising:
transmitting a public key, to a user device, which is paired with a secret key stored in a communication device mounted on a vehicle having a predetermined automated driving level.
